(19) United States
(12) Patent Application Publication
(10) Pub. No.: US 2004/0224056 A1
(43) Pub. Date: Nov. 11, 2004

(54) Split sausages and method and apparatus for producing split sausages

(76) Inventor: John J. Jordan, Cincinnati, OH (US)

Correspondence Address: J. Jason Link, Esq, Kilpatrick Stockton LLP., 1001 West Fourth Street, Winston-Salem, NC, 27101, US

(21) Appl. No.: 10/866,383

(22) Filed: Jun. 10, 2004

Related U.S. Application Data
(62) Division of application No. 10/014,160, filed on Oct. 26, 2001, now abandoned.
(60) Provisional application No. 60/243,868, filed on Oct. 27, 2000.

(51) Int. Cl. A23G 1/00

(52) U.S. Cl. 426/105

(57) ABSTRACT

A split sausage of the present invention comprises a sausage link having an interior and an outer surface surrounding the interior, wherein the sausage link is sliced longitudinally. A process for producing split sausage links comprises receiving a plurality of sausage links and automatically slicing the sausage links longitudinally. The sausage links are sliced to a depth that is greater than about 50% of its cross-section.

### CROSS-REFERENCE TO RELATED APPLICATIONS

This is a divisional of pending U.S. patent application Ser. No. 10/014,160 filed on Oct. 26, 2001, which is incorporated in full by reference, which claims the benefit of U.S. Provisional Patent Application Serial No. 60/243,868, filed Oct. 27, 2000, which is incorporated in full by reference.

### FIELD OF THE INVENTION

The present invention relates generally to the production of meat products sold in link form and, in particular, to split link sausage, a method for producing split link sausage and an apparatus for producing split link sausage.

### BACKGROUND OF THE INVENTION

Sausage is typically sold as either sausage links or sausage patties. Sausage patties are formed by slicing a long, generally cylindrical sausage into disc-shaped patties. Link sausage is typically formed by stuffing the sausage ingredients into a casing and is generally cylindrical in shape.

For sandwiches and biscuits, sausage patties have been preferred because they are flat and fit better inside the sandwich or biscuit. It would be desirable to have sausage links that can open up for use in sandwiches, buns and biscuits. With an open sausage link, the sandwich or biscuit would have more of an authentic “real sausage” appeal. There are also perceived taste and other organoliptic differences between sausage links and sausage patties: Sausage links are usually spicier than sausage patties because, in general, it is easier to impart flavoring to a sausage link than to a sausage patty. The weight of sausage links is more easily controlled than the weight of sausage patties.

It would also be desirable to have a satisfactory method and apparatus for splitting sausage. Attempts to split sausage using the blade in a sausage peeler have been unsuccessful. A sausage peeler takes a string of sausages after they are cooked and chilled, and removes the casing. The links are connected at the ends. The peeler uses a knife to score the casing so that the links can come out, and it takes the casing away while transporting the peeled sausages to the next station. It was thought that a deeper knife could be used in the peeler both to cut the casing and to cut and split the sausage. The problem with this approach is that pieces of plastic casing get pushed into the split sausage by the knife. The pieces of casing will not be discovered until the consumer bites into the sausage or a cook sees the casing pieces melt on the grill.

Hot dogs and frankfurters have been slit in the past to facilitate tenderizing for grilling. U.S. Pat. Nos. 2,675,580 and 2,776,480 both relate to devices for manually slitting hot dogs and frankfurters. These patents do not discuss splitting in a manner such that the hot dogs may be opened prior to cooking.

### SUMMARY OF THE INVENTION

The present invention relates to split meat products in a link form, such as sausage and hot dogs. While the term sausage is frequently used herein, it is to be understood that any meat product manufactured and sold in link form, such as hot dogs, may also be split using the process and apparatus of the present invention. In general there are two types of meat products sold in link form: coarse ground meat products and emulsified meat products. Sausage is an example of a coarse ground meat product. The preferred sausage for use in the process and apparatus of the present invention is a full length, skinless, link sausage. An apparatus of the present invention could also be used to split a natural casing sausage.

Examples of emulsified meat products include bratwurst and hot dogs. Emulsified meat products are easier to split because they are denser (i.e., comprise smaller meat particles) than coarse ground meat products.

The present invention relates to a process for splitting sausage. In one embodiment of a process of the present invention, meat batter is stuffed into a casing using a linker. The linker twists the casing to form individual and connected sausages. The connected sausages in the casing are cooked and smoked in a smokehouse. After cooking and smoking, the casing is removed using a peeler. The peeler makes a very small slit in the casing and then vacuums the casing off of the sausages. The sausages leave the peeler at a fairly high rate of speed and are transported to a rotating, round blade. The alignment of the sausages is maintained such that the blade cuts the sausages longitudinally. The split sausages are then packaged and shipped.

The present invention also relates to an apparatus for splitting sausages. In one embodiment of the present invention, the apparatus may be connected to a peeler, such that sausages leaving the peeler are transported to the apparatus. The apparatus includes rollers to transport the sausages through the apparatus. In an embodiment of the present invention where the apparatus is connected to a sausage peeler, guide rollers may be positioned below the sausage to guide the sausage and maintain its alignment. In this embodiment, the sausages leave the peeler with enough momentum to move through the apparatus of the present invention such that the rollers do not need to be powered. In another embodiment, rollers are positioned above and below the sausage, where the rollers below the sausage links are active and move the sausages while the rollers above the sausage links are idle and assist in guiding the sausages. An apparatus of the present invention may also comprise a guide tube to maintain the alignment of the sausages as they exit the peeler and enter the apparatus. The apparatus further comprises a blade, which splits the sausages by cutting them. The blade is preferably round and is driven by a motor. While an apparatus could be designed with a blade that rotates in either direction, the blade preferably rotates in the same direction as the sausages are moving through the apparatus. The rollers and a guide tube maintain the position and alignment of the sausages such that the blade cuts the sausages in the middle. The blade is preferably set at a depth that does not cut all the way through the sausage. Rather than adjusting the cutting depth by moving the blade, the height may also be adjusted by changing the blade (i.e., using blades with smaller or larger diameters). A portion of each sausage is uncut in order for the sausage link to be opened for cooking and eating.

The present invention further includes split sausages. A split sausage of the present invention comprises a pre-sliced sausage having an outer surface, an interior, and a longitudinal slice having a depth, such that the slice extends through the outer surface and into at least a portion of the interior. The outer surface acts as a hinge for the split sausage. The sausage may be sliced to any depth sufficient to allow the sausage to be opened without tearing. The sausage is preferably sliced to a depth that is greater than about 50% of its cross-section and more preferably to a depth that is between about 70% and about 80% of its cross-section. For example, if the sausage has a circular cross-section, then the sausage link is sliced to a depth that is at least 50% of its diameter. In another aspect of the present invention, the sausage is sliced to a uniform depth through the length of the sausage. As the sausages of the present invention are preferably skinless, the outer surface is formed during the cooking and smoking of the sausage as described in greater detail below. The sausage should not be sliced through this outer surface as the outer surface acts as a hinge for the split sausage.

The present invention also relates to split or pre-sliced emulsified meat products sold in link form, such as hot dogs and bratwurst. For example, a split hot dog of the present invention comprises a hot dog having an outer surface, an interior, and a longitudinal slice having a depth, such that the slice extends through the outer surface and into at least a portion of the interior. The outer surface may act as a hinge for the hot dog. The hot dog may be sliced to any depth sufficient to allow the sausage to be opened without tearing. For example, the hot dog may be sliced to a depth that is at least 50% of its diameter. The present invention also includes split or pre-sliced sausages (or other meat products sold in link form) that are prepared by a process of the present invention. Split sausages prepared using the process of the present invention are advantageous to split sausages prepared using other methods as the sausages are split in-line during their manufacture, resulting in a more efficient production of the split sausages. The depth of the cut in the split sausages is also uniform as the blade height is fixed.

It is a feature and advantage of the present invention to provide a split sausage or hot dog that can be opened and placed in a sandwich, biscuit or bun.

It is another feature and advantage of the present invention to provide a split sausage that gives an authentic “real sausage” appeal when placed in a sandwich, biscuit or bun.

It is a further feature and advantage of the present invention to provide a split sausage that provides the functionality of a sausage patty for use in a sandwich with the added flavor associated with sausage links.

Another feature and advantage is that a process of the present invention may be continuous and in-line with a sausage link manufacturing processes.

A further feature and advantage of the present invention is that the process operates at a high throughput.

It is a still further feature and advantage of the present invention to provide an apparatus for splitting sausage that is easily implemented in existing manufacturing processes.

It is a further feature and advantage of the present invention to provide an apparatus that can split sausages as they exit a sausage peeler at a high rate of speed.

Another feature and advantage of the present invention is to provide an apparatus for splitting sausages that is easily cleaned. The apparatus of the present invention advantageously has a minimal number of crevices and other small locations where bacteria and other contaminants might collect.

A further feature and advantage of the present invention is to provide an apparatus for splitting sausages that reduces the chances that the sausage links will have casing caught in the split.

A still further feature and advantage of the present invention is to provide an apparatus for splitting sausages that includes appropriate safety protections.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE FIGURES

FIG. 1 is a side elevational view of an embodiment of a split sausage according to the present invention where the split sausage is closed;

FIG. 2 is an end elevational view of an embodiment of a split sausage according to the present invention where the split sausage is closed;

FIG. 3 is a top elevational view of an embodiment of a split sausage according to the present invention where the split sausage is closed;

FIG. 4 is a side elevational view of an embodiment of a split sausage according to the present invention where the split sausage is open;

FIG. 5 is an end elevational view of an embodiment of a split sausage according to the present invention where the split sausage is open;

FIG. 6 is a top elevational view of an embodiment of a split sausage according to the present invention where the split sausage is open;

FIG. 7 is a schematic of the components and process steps in an embodiment of a process of the present invention;

FIG. 8 is a schematic of an embodiment of a apparatus of the present invention;

FIG. 9 is a schematic of an embodiment of an apparatus of the present invention connected to a peeler;

FIG. 10 is a schematic of another embodiment of an apparatus of the present invention;

FIG. 11 is an end view of a roller that may be used in an embodiment of an apparatus of the present invention; and

FIG. 12 is a side view of a roller that may be used in an embodiment of an apparatus of the present invention.

### DETAILED DESCRIPTION OF THE DRAWINGS

The present invention relates to a process for splitting sausages and an apparatus for splitting sausages. The present invention also relates to split or pre-sliced meat products in a link form, such as sausage and hot dogs. While the term sausage is frequently used herein, it is to be understood that any meat product manufactured and sold in link form, such as hot dogs, may also be split using the process and apparatus of the present invention. In general there are two types of meat products sold in link form: coarse ground meat products and emulsified meat products. Sausage is an example of a coarse ground meat product. The preferred sausage for use in the process and apparatus of the present invention is a full length, skinless, link sausage. An apparatus of the present invention could also be used to split a natural casing sausage. As will be discussed below, although the sausage is skinless in that it is not stuffed into and sold in a natural casing, skinless sausages do have an outer surface (which is actually sometimes called a “skin”), which is tough meat on the outside of the sausage formed when the sausage is cooked and smoked.

Examples of emulsified meat products include bratwurst and hot dogs. Emulsified meat products are easier to split because they are denser (i.e., comprise smaller meat particles) than coarse ground meat products.

In the present invention, the sausage may comprise at least one meat, such as, for example, beef, pork, turkey, chicken, ostrich, buffalo, seafood, and other animal products. A meat product may comprise a meat source, seasonings, flavorings, fillers, preservatives, and/or other ingredients known to those of skill in the art.

While the present invention preferably relates to meat products and methods and apparatuses for producing meat products, the methods and apparatuses of the present invention may also be used to produce split imitation meat products (e.g., vegetarian products) in link form. For example, methods and apparatuses of the present invention may be used to produce split vegetarian hot dogs.

In using the process and apparatus of the present invention, the sausage is sliced longitudinally, but not through the entire cross-section of the sausage, such that the sausage may be opened, cooked and served. The split sausage of the present invention can be advantageously served on a biscuit, sandwich or bun as the open split sausage is generally flat, similar to a sausage patty, while providing the flavor and texture of a link sausage.

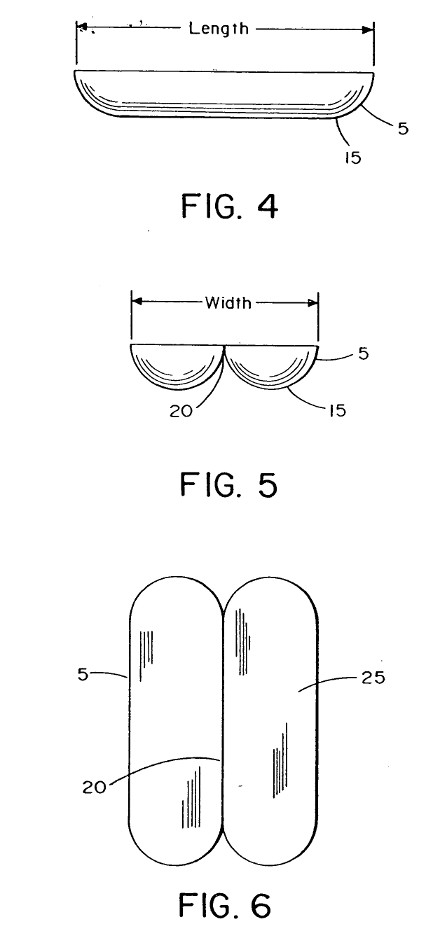

The present invention also includes sausage biscuits, comprising a bread product and a split sausage of the present invention. Examples of useful bread products include biscuits, rolls, buns and sliced bread. The split sausage is open on the bread product (see FIGS. 4 to 6).

An embodiment of a split sausage of the present invention comprises a pre-sliced link sausage having an outer surface, an interior, and a longitudinal slice having a depth, such that the slice extends through the outer surface and into at least a portion of the interior. The pre-sliced link sausage is hinged by the outer surface. The sausage may be sliced to any depth sufficient to allow the sausage to be opened without tearing. In one embodiment, the sausage is sliced to a depth that is greater than about 50% of its cross-section. In other embodiments, the sausage is sliced longitudinally to a depth that is between about 70% and about 80% of its cross-section. For example, if the sausage has a circular cross-section, then the sausage may be sliced to a depth that is at least 50% of its diameter. In another embodiment, the sausage is sliced longitudinally to a depth that is about 70-80% of its diameter. In a further embodiment, the sausage is sliced longitudinally to a depth that is at least seven-eighths (⅞) of its diameter. Other slicing depths may be used. As noted above, in selecting a slicing depth, it is important to avoid slicing the sausage too deep to avoid possible tearing of the hinge between the two halves of the sausage when it is opened. Further, it is also important to avoid slicing the sausage too shallow as the split sausage may not open easily or evenly. As noted above, split sausages of the present invention are preferably skinless. The outer surface is formed during the cooking and smoking of the sausage. When the sausage is cooked, it is treated with smoke (either liquid or gaseous) for flavor, color, and microbial protection. The smoke also reacts with the meat on the outer surface of the sausage to create a thin layer of meat with a tougher texture than the rest of the meat in the interior of the sausage. This tough meat on the outer surface acts as a hinge for the sausage. Thus, the sausage can be opened “butterfly style” without breaking in half.

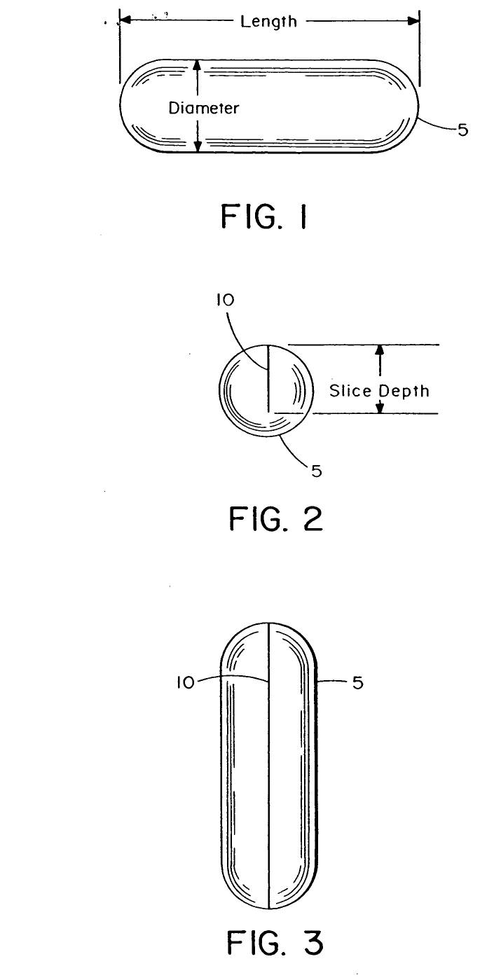

Referring now to the figures, FIGS. 1 to 6 illustrate an embodiment of a split or pre-sliced link sausage of the present invention. In FIGS. 1 to 3, the split sausage is closed, while in FIGS. 4 to 6, the sausage is open. FIG. 1 shows a side view of an embodiment of a split sausage 5, with length and diameter being shown. FIG. 2 shows an end view of the split sausage 5 having a longitudinal slice 10. As shown in FIG. 2, the slice depth is a distance greater than 50% of the diameter. For example, in an embodiment where the sausages are 4.125 inches (104.8 mm) long and have a diameter of 1.3 inches (33 mm), an acceptable slice depth may be 0.9 inches (23 mm). In this embodiment, the sausage has a target weight of 2.75 ounces per link. Other slice depths may be used, so long as the sausage is not sliced to a depth at which the outer surface forming the hinge will tear too easily. FIG. 3 is a top view of the split sausage 5 having a longitudinal slice 10.

FIGS. 4 to 6 show an embodiment of a split sausage that is open. The split sausage 5 is opened “butterfly” style. FIG. 4 is a side view of the split sausage 5 having an outer surface 15. FIG. 5 is an end view of the split sausage 5 having an outer surface 15. As the split sausage 5 is open, the width of the split sausage, in this embodiment, is equal to approximately twice the diameter of the split sausage 5. FIG. 5 also illustrates how the outer surface 15 of the split sausage 5 acts as a hinge 20 when the split sausage is opened. FIG. 6 is a top view of the split sausage 5 showing the interior 25 of the split sausage 5 and the hinge 20.

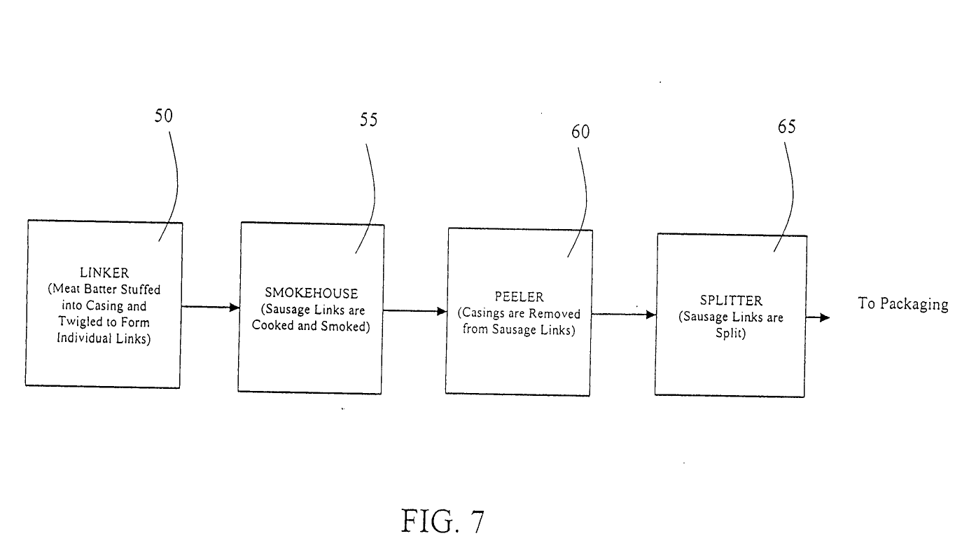

The present invention also includes a process for producing split sausages. FIG. 7 is a schematic of the components and process steps in an embodiment of a process of the present invention for splitting sausage. In one embodiment of a process, meat batter is stuffed 50 into a casing using a linker. Various meat batters used for making sausage can be stuffed into the casing. Examples of ingredients used in a meat batter include pork, beef, water, salt, corn syrup, flavoring, dextrose, sodium phosphate, monosodium glutamate, ascorbic acid (vitamin C), and sodium nitrite. Before being mixed in a batter, pork and beef are typically ground to a particle size of less than five thirty-seconds of an inch (5/32″) and preferably less than one-eighth of an inch (⅛″).

The casing is preferably a plastic extruded casing, which will be peeled off after the sausage is made. The linker twists 50 the casing containing the batter to form individual sausage links. The individual links are connected, such that there is a string of sausage links which may be a variety of lengths. The casings are hung on a stick and sent through a smokehouse 55 to be cooked and smoked. In the smokehouse, the sausage is treated with smoke (either liquid or gaseous) for flavor, color and microbial protection. As noted above, the smoke reacts with the meat to form an outer surface of the sausage which is a thin layer of meat with a tougher texture than the rest of the meat on the interior of the sausage. When the sausage is sliced and opened, the outer surface acts as a hinge for the sausage.

After the sausages are cooked and smoked, the casing must be removed so the consumer can eat it because the casing is constructed of plastic or other inedible materials. The casing is preferably removed by a peeler. An example of a commercially available peeler useful in the present invention is Model No. 2600 available from Townsend Engineering in Des Moines, Iowa. The peeler pulls a string of sausages into it, makes a small slit in the casing and then pulls it off. The sausages are sent along for further processing and the removed casing is preferably removed by vacuum.

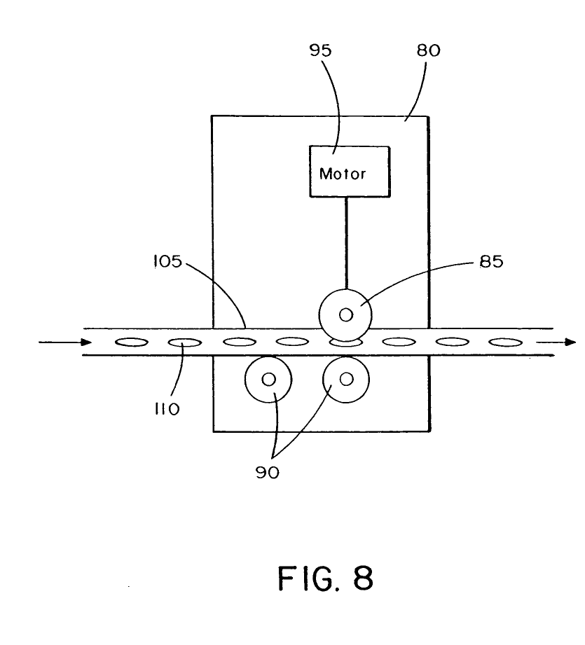

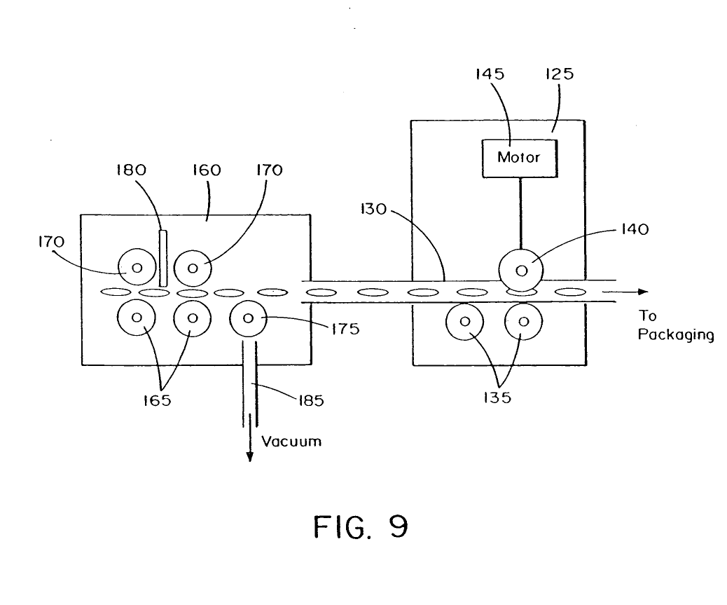

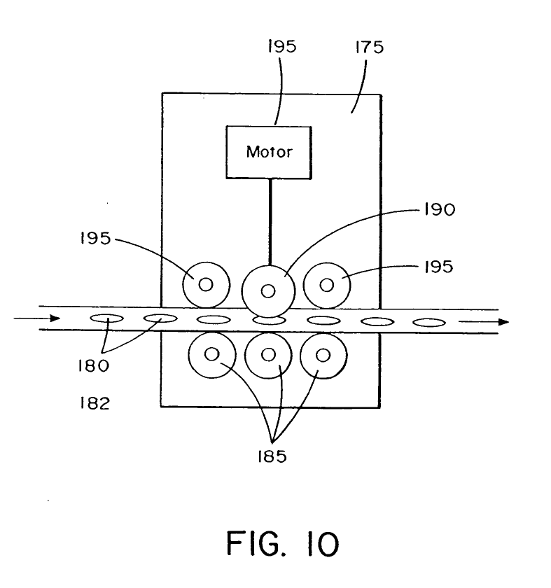

In an embodiment of a process of the present invention, the sausages leave the peeler and enter an apparatus of the present invention, which will also be referred to herein as a splitter. The speed of the sausages entering the splitter should be optimized to maximize throughput while minimizing lost product. In one embodiment, the sausages exit the peeler and enter the splitter at a rate of about four to six feet per second. The sausages are preferably aligned end-to-end as they enter the splitter. The sausages are aligned in this manner as they exit the peeler and the alignment is maintained using rollers and a guide tube (as shown in FIGS. 8 and 9). The sausages are cut 60 in the splitter using a rotating, circular blade. The sausages are preferably cut longitudinally down the middle and to a depth that will enable the sausages to be opened “butterfly” style. The operation of the splitter will be described in greater detail with regard to FIGS. 8-10. After the sausages are split, they may then be sent to be packaged. The sausages may be packaged in any number of ways known to those of ordinary skill in the art.

In one embodiment, sausages produced in accordance with the present invention are 4.125 inches (104.8 mm) long and have a diameter of 1.3 inches (33 mm) with a target weight of 2.75 ounces. In this embodiment, the sausage may be sliced to a depth of 0.9 inches (23 mm).

The present invention also relates to an apparatus for splitting sausage links, which may also be called a sausage splitter. FIGS. 8 and 9 illustrate embodiments of an apparatus of the present invention that may be connected to a peeler. In FIG. 8, sausages 110 are shown entering the apparatus 80 from the peeler. The sausages 110 are aligned end-to-end and the alignment is maintained by a guide tube 105. The guide tube 105 is preferably constructed from stainless steel. The sausages 110 preferably exit the peeler and enter the apparatus at speeds between about four and six feet per second although other speeds may be used with a goal of maximizing throughput while minimizing lost product. The momentum of the sausages leaving the peeler is sufficient to transport them through the splitter 80 and to additional processing steps, such as packaging. The sausages are guided and aligned through the apparatus by guide rollers 90. To assist in guiding and aligning the sausages, the guide rollers 90 may be V-shaped rollers. In the embodiment shown in FIG. 8, the guide rollers are not powered, but rotate with the sausages 110 as they pass over. As noted above, the rollers 90 and guide tube 105 align the sausages 110 as it is important for the sausages to be properly aligned before being sliced. While three idle rollers 90 are shown in FIG. 8, any number of rollers, both powered and unpowered, may be used as will be illustrated with regard to FIG. 10.

The sausages 110 are split by a rotating blade 85. The blade 85 is powered by an attached motor 95. While the blade 85 may be powered by its own motor 90, the blade 85 may also be connected to the motor on the peeler to provide a more efficient operation. The blade 85 is preferably round and rotates in the same direction as the sausages are traveling. In other embodiments, the blade may be stationary or may rotate in a direction opposite to the movement of the sausages. The diameter of the blade may vary depending on the depth at which the sausage should be sliced. Additionally, non-round blades may also be used. In one embodiment, for sausages having a length of four to five inches, the diameter of the blade 85 may be four inches. The depth of the slice in the sausages may be adjusted in a few ways. The preferred method of adjusting the depth of the slice in the sausage is to use blades of varying diameters. Another method would involve adjusting the height of the blade.

FIG. 9 shows an embodiment where the apparatus 125 is connected to a peeler 160, such that the splitting of the sausages is performed in-line during the production of sausages. The components shown for the splitter of FIG. 8 are also shown in FIG. 9. The sausages are moved through the peeler 160 by drive rollers 165 and idle rollers 170. The sausages are moved past a blade 180, which makes a small slit in the casing and then pulls it off. The sausages with the casing then pass a vacuum roller 175, where the casing is removed from the sausages by a vacuum 185. The sausages then exit the peeler 160 and enter the splitter 125.

The momentum of the sausages leaving the peeler is sufficient to transport them through the splitter 125. The sausages move through the splitter 125 in a guide tube 130 and are guided and aligned by guide rollers 135. In the embodiment shown in FIG. 9, the guide rollers 135 are not powered, but rotate with the sausages as they pass over. The sausages move past the blade 140, which slices the sausages longitudinally to a predetermined depth. As noted above, the depth of the slice in the sausages may be adjusted by using blades of varying diameters or by adjusting the height of the blade 140. In selecting a slicing depth, it is important to avoid slicing the sausage too deep to avoid possible tearing of the hinge between the two halves of the sausage when it is opened. Further, it is also important to avoid slicing the sausage too shallow as the split sausage may not open easily or evenly. In one embodiment, the sausages are sliced to a depth that is greater than 50% of their diameter. In other embodiments, the sausages are sliced to a depth that is between 70% and 80% of their diameter.

FIG. 10 is a schematic of another embodiment of an apparatus 175 of the present invention. In FIG. 10, sausages 180 are shown entering the apparatus 175. The sausages 110 are aligned end-to-end and the alignment is maintained by a guide tube 182. In this embodiment, the sausages 110 may not have enough momentum to move through the apparatus, so drive rollers 185 are used to move them. The drive rollers may be powered by their own motors or may be connected the motor 195 that powers the blade 190. Any number of drive rollers 195 may be used so long as the sausages move through the apparatus 175 at a sufficient speed to maximize throughput and minimize lost product.

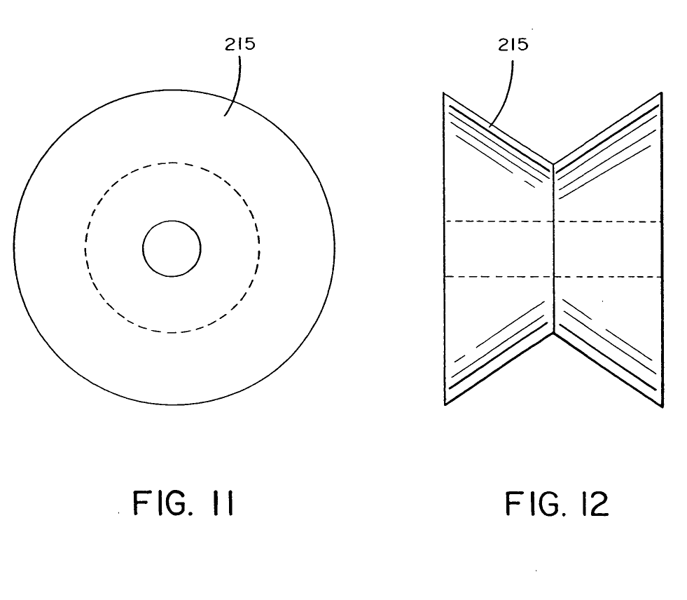

The apparatus 175 shown in FIG. 10 also includes guide rollers 195, which are preferably not powered. The guide rollers 195 assist in guiding the sausages through the apparatus 175 and maintaining their alignment. The present invention preferably uses rollers, both guide and drive rollers, that are V-shaped. FIG. 11 is an end view of a V-shaped roller 215 that can be used in an embodiment of the present invention.

FIG. 12 is a side view of the roller 215 shown in FIG. 11. Rather than using V-shaped rollers, rollers having other cross-sections may also be used. In addition to rollers, sausages may be moved through an apparatus of the present invention in other ways, such as by a belt conveyor or by brushes.

The sausages 180 are split by a rotating blade 190. The blade is powered by an attached motor 195. The blade 190 is preferably round and rotates in the same direction as the sausages are traveling. In other embodiments, the blade may be stationary or may rotate in a direction opposite to the movement of the sausages. Additionally, non-round blades may also be used.

While the present invention refers generally to sausage, the present invention is equally applicable to other meat products that are typically sold or processed as links, such as emulsified meat products. Examples of emulsified meat products include bratwurst and hot dogs. Emulsified meat products are split more easily than coarse ground meat products. Emulsified meat products have smaller particle sizes (typically, less than 1.4 mm) and are more dense (i.e., more tightly packed) than coarse ground meat products.

A split hot dog of the present invention comprises a pre-sliced hot dog having an outer surface, an interior, and a longitudinal slice having a depth, such that the slice extends through the outer surface and into at least a portion of the interior. The outer surface acts as a hinge when the split hot dog is opened or closed. A split hot dog of the present invention may be sliced to a variety of depths. In selecting a slicing depth, it is important to avoid slicing the hot dog too deep to avoid possible tearing of the hinge between the two halves of the hot dog when it is opened. Further, it is also important to avoid slicing the hot dog too shallow as the hot dog may not open easily or evenly. In one embodiment, a hot dog is sliced to a depth that is greater than 50% of its diameter. In other embodiments, the hot dog is sliced to a depth that is between 70% and 80% of its diameter.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

That which is claimed:

1. A process for producing split sausage links, comprising:
receiving a plurality of sausage links; and
automatically slicing the sausage links longitudinally.

2. The process of claim 1, wherein the sausage links are sliced to a depth that is greater than about 50% of its cross-section.

3. The process of claim 1, wherein the sausage links are sliced to a depth that is between about 70% and about 80% of its cross-section.

4. The process of claim 1, further comprising stuffing a casing with meat batter.

5. The process of claim 4, further comprises twisting the casing to form a plurality of sausage links.

6. The process of claim 5, further comprising removing the casing.

7. The process of claim 1, further comprising cooking the sausage links.

8. The process of claim 1, further comprising aligning the plurality of sausage links before automatically slicing the sausage links.
